(19) United States
(12) Patent Application Publication
(10) Pub. No.: US 2003/0041176 A1
(43) Pub. Date: Feb. 27, 2003

(54) Data transfer algorithm that does not require high latency read operations

(76) Inventors: John William Court, Carrara (AU); Anthony George Griffiths, Mudgeeraba (AU)

Correspondence Address: GLENN PATENT GROUP, 3475 EDISON WAY, SUITE L, MENLO PARK, CA, 94025, US

(21) Appl. No.: 09/929,901

(22) Filed: Aug. 14, 2001

(51) Int. Cl. G06F 15/16; G06F 15/173

(52) U.S. Cl. 709/251; 709/238

(57) ABSTRACT

A mechanism is provided for the controlled transfer of data across LDT and PCI buses without requiring any high latency read operations. The preferred embodiment of the invention removes the need for any read accesses to a remote processor's memory or device registers, while still permitting controlled data exchange. This approach provides significant performance improvement for systems that have write buffering capability.

### BACKGROUND OF THE INVENTION

1. Technical Field

The invention relates to computer networks. More particularly, the invention relates to a data transfer algorithm that does not require high latency read operations.

2. Description of the Prior Art

LDT (Lightning Data Transport, also known as HyperTransport) is a point-to-point link for integrated circuits (see, for example, http://www.amd.com/news/prodpr/21042.html). Note: HyperTransport is a trademark of Advanced Micro Devices, Inc. of Santa Clara, Calif.

HyperTransport provides a universal connection that is designed to reduce the number of buses within the system, provide a high-performance link for embedded applications, and enable highly scalable multiprocessing systems. It was developed to enable the chips inside of PCs, networking, and communications devices to communicate with each other up to 24 times faster than with existing technologies.

Compared with existing system interconnects that provide bandwidth up to 266 MB/sec, HyperTransport technology's bandwidth of 6.4 GB/sec represents better than a 20-fold increase in data throughput. HyperTransport provides an extremely fast connection that complements externally visible bus standards such as the Peripheral Component Interconnect (PCI), as well as emerging technologies such as InfiniBand. HyperTransport is the connection that is designed to provide the bandwidth that the InfiniBand standard requires to communicate with memory and system components inside of next-generation servers and devices that power the backbone infrastructure of the telecomm industry. HyperTransport technology is targeted primarily at the information technology and telecomm industries, but any application in which high speed, low latency and scalability is necessary can potentially take advantage of HyperTransport technology.

HyperTransport technology also has a daisy-chainable feature, giving the opportunity to connect multiple HyperTransport input/output bridges to a single channel. HyperTransport technology is designed to support up to 32 devices per channel and can mix and match components with different bus widths and speeds.

The peripheral component interconnect (PCI) is a peripheral bus commonly used in PCs, Macintoshes, and workstations. It was designed primarily by Intel and first appeared on PCs in late 1993. PCI provides a high-speed data path between the CPU and peripheral devices, such as video, disk, network, etc. There are typically three or four PCI slots on the motherboard. In a Pentium PC, there is generally a mix of PCI and ISA slots or PCI and EISA slots. Early on, the PCI bus was known as a “local bus.”

PCI provides “plug and play” capability, automatically configuring the PCI cards at startup. When PCI is used with the ISA bus, the only thing that is generally required is to indicate in the CMOS memory which IRQs are already in use by ISA cards. PCI takes care of the rest.

PCI allows IRQs to be shared, which helps to solve the problem of limited IRQs available on a PC. For example, if there were only one IRQ left over after ISA devices were given their required IRQs, all PCI devices could share it. In a PCI-only machine, there cannot be insufficient IRQs, as all can be shared.

PCI runs at 33 MHz, supports 32- and 64-bit data paths and bus mastering. PCI Version 2.1 calls for 66 MHz, which doubles the throughput. There are generally no more than three or four PCI slots on the motherboard, which is based on ten electrical loads that deal with inductance and capacitance. The PCI chipset uses three loads, leaving seven for peripherals. Controllers built onto the motherboard use one, whereas controllers that plug into an expansion slot use 1.5 loads. A “PCI bridge” can be used to connect two PCI buses together for more slots.

The Agile engine manufactured by AgileTV of Menlo Park, Calif. (see, also, T. Calderone, M. Foster, System, Method, and Node of a Multi-Dimensional Plex Communication Network and Node Thereof, U.S. patent application Ser. No. 09/679,115 (Oct. 4, 2000)) uses the LDT and PCI technology in a simple configuration, where an interface/controller chip implements a single LDT connection, and the Agile engine connects two other interface/controller chips (such as the BCM12500 manufactured by Broadcom of Irvine, Calif.) on each node board using LDT. Documented designs also deploy LDT in daisy-chained configurations and switched configurations.

When connecting multiple processor integrated circuits via a high speed bus, such as LDT and PCI, which allows remote memory and device register access, certain operations can impede throughput and waste processor cycles due to latency issues. Multi-processor computing systems, such as the Agile engine, have such a problem. The engine architecture comprises integrated circuits that are interconnected via LDT and PCI buses. Both buses support buffered, e.g. posted, writes that complete asynchronously without stalling the issuing processor. In comparison, reads to remote resources stall the issuing processor until the read response is received. This can pose a significant problem in a high speed, highly pipelined processor, and can result in the loss of a large number of compute cycles.

It would be advantageous to provide a mechanism for the controlled transfer of data across LDT and PCI buses without requiring any high latency read operations. In particular, it would be advantageous to provide a mechanism that could accomplish the effect of a read operation through the use of a write operation.

### SUMMARY OF THE INVENTION

The invention provides a mechanism for the controlled transfer of data across LDT, PCI and other buses without requiring any high latency read operations as part of such data transfer. The preferred embodiment of the invention removes the need for any read accesses to a remote processor's memory or device registers, while still permitting controlled data exchange. This approach provides significant performance improvement for any systems that have write buffering capability.

In operation, each processor in a multiprocessor system maintains a set of four counters that are organized as two pairs, where one pair is used for the transmit channel and the other pair is used for the receive channel.

At the start of an operation all counters are initialized to zero and are of such size that they cannot wrap, e.g. they are at least 64 bits in size in the preferred embodiment.

One processor, e.g. processor “B,” allocates receive buffer space locally and transfers the addresses of this space to another processor, e.g. processor “A.”

Processor “B” increments a “Local Rx Avail” counter by the number of local buffers and then writes this updated value to a “Remote Tx Avail” counter in processor “A”'s memory. At this point, both counters have the same value.

Processor “A” is now able to transfer data packets. It increments a “Local Tx Done” counter after each packet is sent until “Remote Tx Avail” minus “Local Tx Done” is equal to zero. This indicates that the entire remote buffer allocation has been used.

At any time, the current value of the “Local Tx Done” counter on processor “A” can be written to the “Remote Rx Done” counter on processor “B.”

Processor “B” can determine the number of completed transfers by subtracting “Remote Rx Done” from “Local Rx Avail” and can process these buffers accordingly. Once processed, the buffers can be freed or re-used with the cycle repeating when processor “B” again allocates receive buffer space locally and transfers the buffer addresses to processor “A.”

The transmit channel from processor “B” to processor “A” is a mirror image of the procedure described above.

### BRIEF DESCRIPTION OF THE DRAWINGS

FIG. 1 is a block schematic diagram showing two processors that are configured to implement the herein disclosed algorithm for avoiding high latency read operations during data transfer using a memory to memory interconnect according to the invention; and

FIG. 2 is a flow diagram that shows operation of the herein described algorithm.

### DETAILED DESCRIPTION OF THE INVENTION

The invention provides a novel data transfer algorithm that avoids high latency read operations during data transfer when using a memory to memory interconnect. The presently preferred embodiment of the invention provides a mechanism for the controlled transfer of data across LDT, PCI, and other buses without requiring any high latency read operations as part of such data transfer. The preferred embodiment of the invention removes the need for any read accesses to a remote processor's memory or device registers, while still permitting controlled data exchange. This approach provides significant performance improvement for systems that have write buffering capability.

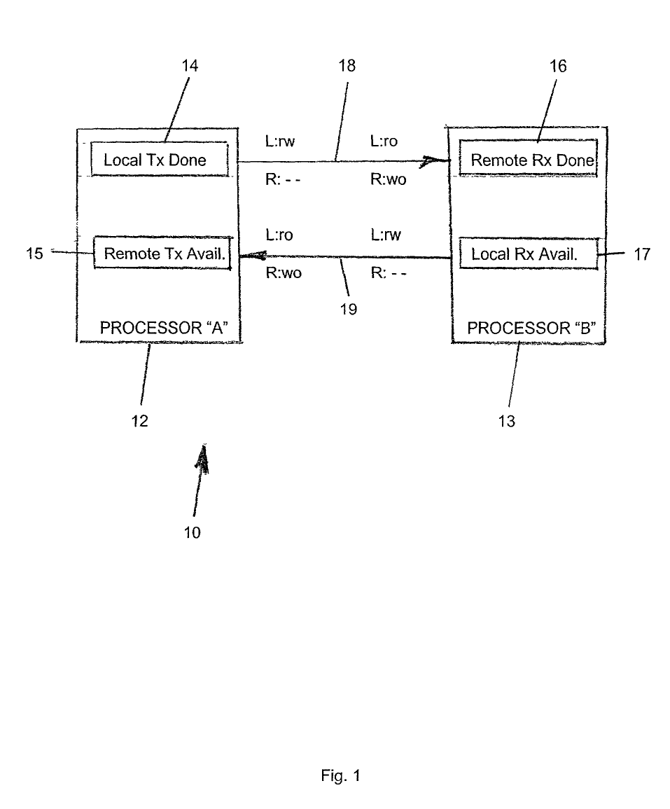

FIG. 1 is a block schematic diagram showing two processors that are configured to implement the herein disclosed algorithm. In FIG. 1 a system 10 includes two processors, i.e. processor “A” 12 and processor “B” 13. It will be appreciated by those skilled in the art that although only two processors are shown, the invention herein is intended for use in connection with any number of processors.

Processor “A” is shown having two counters: a local packets sent counter, i.e. “Local Tx Done” 14 and a remote buffers available counter, i.e. “Remote Tx Avail” 15. Processor “B” also has a similar pair of counters, but they are not shown in FIG. 1.

Processor “B” is shown having two counters: a remote packets received counter, i.e. “Remote Rx Done” 16 and a local buffers available counter, i.e. “Local Rx Avail” 17. Processor “A” also has a similar pair of counters, but they are not shown in FIG. 1.

Two data exchange paths are shown in FIG. 1, where data are exchanged from processor “A” to processor “B” 18, and where data are exchanged from processor “B” to processor “A” 19. The two independent transmission and reception processes are comprised of two state machines, rather than a single state machine.

The various counters shown on FIG. 1 are labeled in accordance with the following access scheme:

| | |
|---|---|
| L: | Local processor access modes |
| R: | Remote processor access modes |
| rw | Read/Write access |
| ro | Read Only access |
| wo | Write Only access |
| — | No access |

In operation, each processor maintains a set of four counters that are organized as two pairs, where one pair of counters is used for the transmit channel and the other pair of counters is used for the receive channel. As discussed above, only one channel is shown for each processor.

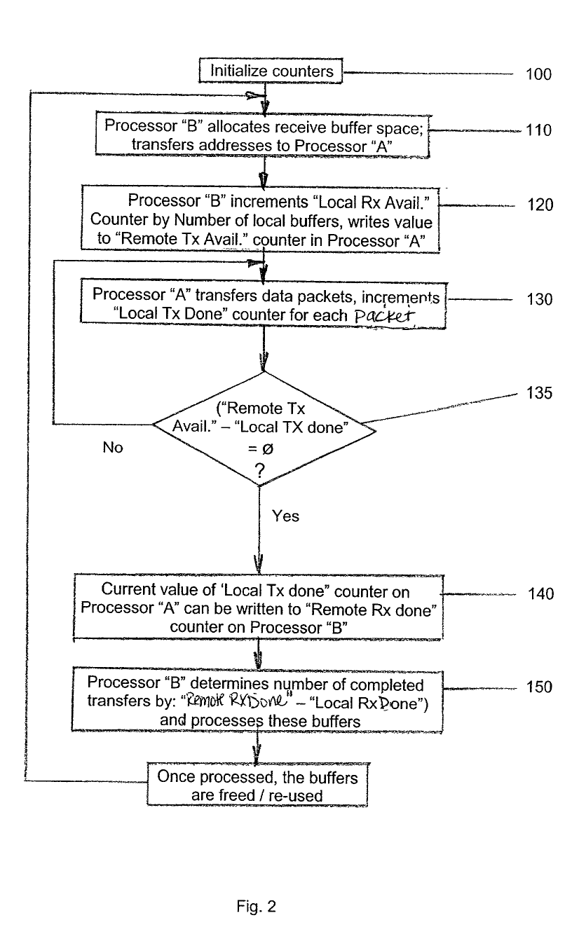

FIG. 2 is a flow diagram that shows operation of the herein described algorithm. Note that the two state machines described in FIG. 2 run largely asynchronously with each other.

At the start of an operation (100) all counters are initialized to zero and are of such size that they cannot wrap, e.g. they are at least 64 bits in size in the preferred embodiment, although they may be any size that avoids wrapping and that is appropriate for the system architecture.

One processor, e.g. processor “B,” allocates receive buffer space locally and transfers the addresses of the allocated buffers to another processor, e.g. processor “A” (110).

Processor “B” increments a “Local Rx Avail” counter by the number of local buffers and then writes this updated value to a “Remote Tx Avail” counter in processor “A”'s memory (120). Processor “A” now knows how many buffers are available for it's use and what the addresses of these buffers are.

Processor “A” is now able to transfer data packets (130).

Processor “A” increments a “Local Tx Done” counter after each packet is sent to processor “B” until “Remote Tx Avail” minus “Local Tx Done” is equal to zero (135), and there are therefore no additional buffers available at processor “B,” or until all packets have been sent, whichever occurs first.

At any time, the current value of the “Local Tx Done” counter on processor “A” can be written to the “Remote Rx Done” counter on processor “B” (140).

Processor “B” can determine the number of completed transfers by the subtraction of “Local Rx Done” from “Remote Rx Done” and can process these buffers accordingly (150).

Once processed, the buffers can be freed or re-used with the cycle repeating when processor “B” again allocates receive buffer space locally and transfers the address to processor “A” (160).

The transmit channel from processor “B” to processor “A” is a mirror image of the procedure described above.

Thus, in summary, processor “B” allocates buffer space when processor “A” wants to send data to processor “B.” Processor “B” determines the address base that is available for receiving the data from processor “A.” This is typically done ahead of time as an initialization operation, where processor “B” declares an area of memory which is available. This is preferably handled in a ring buffer queue, where each of the elements in the buffer actually is the maximum size. In this way, the system predefines a remote transfer buffer for the data transfer operation. In the presently preferred embodiment, all packets are fixed size. It is acceptable if the packets use less of the buffer space. It is important to note that having a predefined list makes it simple to manage the exchange of data and allocation of buffers remotely, thus avoiding a high latency read operation.

Accordingly, processor “A” now knows the destination addresses which are acceptable for the packets in processor “B” and the number of buffers available. Once processor “A” is finished requesting buffers from processor “B”, it knows the amount of space available for the data transfer, it is therefore not necessary to recommunicate this information.

Processor “A” is able, in examining it's “Local TX Avail” counter, to see that it has room for a certain number of packets. Processor “A” queries it's “Local TX Avail” counter to determine if there is room for information on processor “B.” Processor “A” is then able to transfer data packets to processor “B,” incrementing it's “Local TX Done” counter for each packet that is transferred. As data packets are transferred, the “Local TX Done” counter is incremented. As processor “A” completes it's transfer of packets, it writes a value to the “Remote RX Done” counter of processor “B” from it's “Local TX Done” counter. Thus, the invention locally implements a counter following completion of a data transfer operation that is echoed across the bus to the remote processor.

Processor “B” then knows how many packets it received and can read them locally. Once processor “B,” has read the packets locally it can send a “Remote RX Avail” value to processor “A” from it's “Local TX Avail” counter, telling processor “A” that the packets were read and that buffer space is available for additional data transfers. In this way, the invention avoids all read operations across the bus, and can therefore transfer data very quickly.

Although the invention is described herein with reference to the preferred embodiment, one skilled in the art will readily appreciate that other applications may be substituted for those set forth herein without departing from the spirit and scope of the present invention.

While the preferred embodiment of the invention is discussed above, for example, in connection with the Agile engine, the invention is not limited in any way to that particular embodiment. Thus, the invention is readily used to interconnect two or more microprocessor systems, regardless of the number of cores on each chip, with a memory-like interface, or by an interface that supports common memory addressing. Examples of such interface include, but are not limited to, PCI, LDT, and a direct RAM interface of any sort.

A key aspect of the invention is that there are two devices, each of which has locally coupled memory or I/O registers, which look like memory. In other words, the invention may be applied to any multiprocessor system. The fact that the invention provides an approach that avoids remote read operations means that memory is accessed locally, thereby avoiding latency attendant with the use of a transmission channel (in addition to avoiding the latency attendant with the read operation itself). The invention also provides an approach that achieves flow control of the transmitting processor without attempting to guarantee successful packet delivery at the recipient processor. This is non-intuitive in a lossy environment, in which standard communications protocols with sliding windows operate, but it is appropriate in memory to memory environments which already have error detection capabilities outside the flow control area.

In alternative embodiments of the invention, the memory could be a single, large memory, that is partitioned such that each processor has its own memory space. The invention may be used with either of a shared memory system and a non-shared memory system, as in a network. Thus, the invention is thought to have application in any architecture where there is a connection of two or more CPU's via a high latency interface.

Accordingly, the invention should only be limited by the Claims included below.

1. A data transfer apparatus, comprising:
a first processor;
a second processor in communication with said first processor via a data exchange path;
each processor comprising a corresponding plurality of buffers;
each processor comprising a set of four counters that are organized as two pairs, where one pair of counters is used by a transmit channel via a data exchange path and a second pair of counters is used by a receive channel via a data exchange path;
wherein said processors reserve remote buffers to coordinate the exchange of data packets by writing to said counters remotely and reading from said counters locally;
wherein said processors exchange said data packets with posting operations and without resort to remote read operations.

2. The apparatus of claim 1, said counters comprising for each processor, one each of:
a remote buffers available counter;
a local packets sent counter;
a remote packets received counter; and
a local buffers available counter.

3. The apparatus of claim 2, wherein:
said remote buffers available counter is configured for local processor write only operation and remote processor read only operation;
said local packets sent counter is configured for local processor read and write operation;
said remote packets received counter is configured for local processor write only operation and remote processor read only operation; and
said local buffers available counter is configured for local processor read and write operation.

4. The apparatus of claim 1, wherein said counters are non-wrapping.

5. A method for transferring data, comprising the steps of:
allocating a number of receive buffers locally with a first processor;
transferring addresses of said allocated buffers to a second processor;
said first processor incrementing a local buffers available counter by a number corresponding to the number of local buffers allocated;
said first processor writing said updated value to a remote buffers available counter in said second processor;
said second processor transferring data packets to buffers associated with said first processor;
said second processor incrementing a local packets sent counter after each packet is sent to said first processor until a value in said remote buffers available counter minus a value in said local packets sent counter is equal to zero or until all packets have been sent, which ever occurs first;
writing a current value of said local packets sent counter on said second processor to a remote packets sent counter on said first processor;
said first processor determining a number of completed transfers by subtracting a value in said remote packets sent counter from a value in said local buffers available counter; and
processing said buffers accordingly.

6. A method for transferring data, comprising the steps of:
a first processor allocating buffer space when a second processor wants to send data to said first processor;
said first processor querying a local buffers available counter to determine if there is room for information on said first processor;
said first processor writing a value from said local buffers available counter to a remote buffers available counter in said second processor;
said second processor transferring data packets to said first processor;
said second processor incrementing a local packets transferred counter for each packet that is transferred; and
said second processor writing a value to a remote packets transferred counter of said first processor from said local packets transferred counter;
wherein said first processor knows how many packets it received and can read them locally.

7. The method of claim 6, said first processor sending a remote buffers available value from said local buffers available counter to said second processor once said first processor has read said packets locally.

8. The method of claim 7, wherein said buffers reside in a single, memory, that is partitioned such that each processor has its own memory space.

9. A method for transferring data among two or more processors via a data exchange path, comprising the steps of:
a first processor writing a local buffers available value from a local buffers available counter to a remote buffers available counter in a second processor via said data exchange path;
said second processor transmitting data packets to said first processor;
said second processor incrementing a local packets transferred counter for each packet that is transmitted; and
said second processor writing a value to a remote packets transferred counter of said first processor from said local packets transferred counter;
wherein said first processor knows how many packets it received and can read them locally.

10. A data transfer method, comprising the steps of:
providing a first processor;
providing a second processor in communication with said first processor via a data exchange path;
each processor comprising a corresponding plurality of buffers;
each processor comprising a set of four counters that are organized as two pairs, where one pair of counters is used by a transmit channel via a data exchange path and a second pair of counters is used by a receive channel via a data exchange path;
wherein said processors reserve remote buffers to coordinate the exchange of data packets by writing to said counters remotely and reading from said counters locally;
wherein said processors exchange said data packets with posting operations and without resort to remote read operations.

11. The method of claim 10, said counters comprising for each processor, one each of:
a remote buffers available counter;
a local packets sent counter;
a remote packets received counter; and
a local buffers available counter.

12. The method of claim 11, wherein:
said remote buffers available counter is configured for local processor write only operation and remote processor read only operation;
said local packets sent counter is configured for local processor read and write operation;
said remote packets received counter is configured for local processor write only operation and remote processor read only operation; and
said local buffers available counter is configured for local processor read and write operation.

13. An apparatus for transferring data, comprising:
a first processor for allocating a number of receive buffers locally;
said first processor comprising a mechanism for transferring addresses of said allocated buffers to a second processor;
said first processor comprising a mechanism for incrementing a local buffers available counter by a number corresponding to the number of local buffers allocated;
said first processor comprising a mechanism for writing said updated value to a remote buffers available counter in said second processor;
said second processor comprising a mechanism for transferring data packets to buffers associated with said first processor;
said second processor comprising a mechanism for incrementing a local packets sent counter after each packet is sent to said first processor until a value in said remote buffers available counter minus a value in said local packets sent counter is equal to zero or until all packets have been sent, which ever occurs first;
said second processor comprising a mechanism for writing a current value of said local packets sent counter on said second processor to a remote packets sent counter on said first processor;
said first processor comprising a mechanism for determining a number of completed transfers by subtracting a value in said remote packets sent counter from a value in said local buffers available counter; and
said first processor comprising a mechanism for processing said buffers accordingly.

14. An apparatus for transferring data, comprising:
a first processor for allocating buffer space when a second processor wants to send data to said first processor;
said first processor comprising a mechanism for querying a local buffers available counter to determine if there is room for information on said first processor;
said first processor comprising a mechanism for writing a value from said local buffers available counter to a remote buffers available counter in said second processor;
said second processor comprising a mechanism for transferring data packets to said first processor;
said second processor comprising a mechanism for incrementing a local packets transferred counter for each packet that is transferred; and
said second processor comprising a mechanism for writing a value to a remote packets transferred counter of said first processor from said local packets transferred counter;
wherein said first processor knows how many packets it received and can read them locally.

15. The apparatus of claim 14, said first processor comprising a mechanism for sending a remote buffers available value from said local buffers available counter to said second processor once said first processor has read said packets locally.

16. The apparatus of claim 14, wherein said buffers reside in a single, memory, that is partitioned such that each processor has its own memory space.

17. An apparatus for transferring data among two or more processors via a data exchange path, comprising:
a first processor for writing a local buffers available value from a local buffers available counter to a remote buffers available counter in a second processor via said data exchange path;
said second processor comprising a mechanism for transmitting data packets to said first processor;
said second processor comprising a mechanism for incrementing a local packets transferred counter for each packet that is transmitted; and
said second processor comprising a mechanism for writing a value to a remote packets transferred counter of said first processor from said local packets transferred counter;
wherein said first processor knows how many packets it received and can read them locally.

18. A data transfer method for a system that comprises a first processor and a second processor in communication with said first processor via a data exchange path, wherein each processor comprises a corresponding plurality of buffers, the method comprising the steps of:
providing each processor with a set of counters that are organized as pairs, where one pair of counters is used by a transmit channel via said data exchange path and a second pair of counters is used by a receive channel via said data exchange path;
said processors reserving remote buffers to coordinate the exchange of data packets by writing to said counters remotely and reading from said counters locally; and
said processors exchanging said data packets with posting operations and without resort to remote read operations.

19. A data transfer apparatus for a system that comprises a first processor and at least a second processor in communication with said first processor via a data exchange path, wherein each processor comprises a corresponding plurality of buffers, each said processor comprising:
a remote buffers available counter;
a local packets sent counter;
a remote packets received counter; and
a local buffers available counter.

20. The apparatus of claim 19, wherein:
said remote buffers available counter is configured for local processor write only operation and remote processor read only operation;
said local packets sent counter is configured for local processor read and write operation;
said remote packets received counter is configured for local processor write only operation and remote processor read only operation; and
said local buffers available counter is configured for local processor read and write operation.
